(19) United States
(12) Patent Application Publication
(10) Pub. No.: US 2019/0119612 A1
(43) Pub. Date: Apr. 25, 2019

(54) DETERGENT PACK

(71) Applicant: The Procter & Gamble Company, Cincinnati, OH (US)

(72) Inventors: Graham Peter CALVERT, Sunderland (GB); Sarah Jane MELVILLE, Newcastle upon Tyne (GB)

(21) Appl. No.: 16/167,566

(22) Filed: Oct. 23, 2018

Related U.S. Application Data
(60) Provisional application No. 62/576,671, filed on Oct. 25, 2017.

(51) Int. Cl. C11D 17/04; C11D 3/00; C11D 3/33; C11D 3/37; C11D 3/20; C11D 3/39

(52) U.S. Cl. CPC C11D 17/042; C11D 3/0068; C11D 3/33; C11D 1/825; C11D 3/2086; C11D 3/3942; C11D 3/3711

(57) ABSTRACT

A detergent pack comprising a packaging container containing water-soluble unit-dose detergent products, wherein the container comprising a metallic layer at least partially encasing the products helps to reduce the formation of ammonia in the container. Each of the products comprises a detergent composition, which comprises more than 2.5 grams-active of malodour-generating aminocarboxylic complexing agent.

### FIELD OF THE INVENTION

The present invention is in the field of detergent packs. It relates to detergent packs comprising a metallized packaging container containing water-soluble detergent products.

### BACKGROUND OF THE INVENTION

Cleaning detergent compositions are usually perfumed. Powdered cleaning products usually include perfume sprayed onto the powder. Liquid cleaning products usually include perfume dissolved/emulsified therein. In traditional products, part of the perfume is released from the composition into the headspace of the packaging container providing a pleasant smell each time that the pack is opened or at least for the first few times. Consumers associate the pleasant smell with cleaning capacity and expect to perceive an agreeable smell every time the packaging container is opened.

Water-soluble detergent products in unit dose form, comprising a detergent composition, have become widely available. Unit doses are a convenient and desirable way to dose products to an automatic washing machine (e.g., dish or laundry) given there is no need by the user to measure or otherwise handle the detergent composition directly. The products consist of enveloping water-soluble material that envelopes the detergent composition. The water-soluble enveloping material, usually a film or mould, is usually permeable to relatively small molecules, such as water and amine based malodours such as ammonia. The products are contained in a packaging container which is also usually permeable to small molecules; but in some cases, the rate of malodour generation is faster than the rate of permeation of the malodour to the surrounding environment. In these conditions, the malodour can be concentrated in the headspace and it is released every time that the user opens the packaging container. This malodour is not very pleasant and may connote lack of cleaning. Some amine-comprising actives can generate malodours either from by-products originating from the synthesis thereof, from degradation, or from interaction with other components in the detergent composition. There is a need to provide water-soluble detergent products that contain amine-containing cleaning actives with improved smell (e g , minimizing ammonia in the headspace), but still provide manufactures' formulation flexibility and/or minimize the use of costly raw materials.

### SUMMARY OF THE INVENTION

The present invention attempts to address one or more of these needs based, at least in part, on the surprising discovery that the use of a metallic layer in a packaging container containing certain water-soluble products, helps to mitigate against the formation of ammonia. Without wishing to be bound by theory, the metallic layer helps to prevent atmospheric water molecules from entering through the packaging container and through the enveloping material to the detergent composition to react with certain components thereof such as aminocarboxylic complexing agents. Generally, this agent is capable of sequestering hardness ions, particularly calcium and/or magnesium. The benefit is particularly noticeable when high amounts of aminocarboxlic complexing agents are used, i.e., more than 2.5 grams-active of malodour-generating aminocarboxylic complexing agents. Accordingly, a first aspect of the invention provides for a detergent pack comprising a packaging container containing 3 to 60 water-soluble unit-dose detergent products. The packaging container comprising a metallic layer at least partially encasing the 3 to 60 water-soluble unit-dose detergent products. Each of the water-soluble unit-dose detergent products comprises a detergent composition and an enveloping material enveloping the detergent composition. The detergent composition comprises more than 2.5 grams-active of malodour-generating aminocarboxylic complexing agent.

Another aspect of the invention is directed to the use of a vacuum metalized packaging container for reducing ammonia, within headspace of said container, generated from 5 to 60 of water-soluble unit-dose automatic dishwashing detergent products contained within said container, wherein each of the water-soluble unit-dose detergent products comprises a detergent composition comprising a bleach and at least 2.6 grams-active of aminocarboxylic complexing agent. The elements of the composition of the invention described in connection with the first aspect of the invention apply mutatis mutandis to the second aspect of the invention.

### DETAILED DESCRIPTION OF THE INVENTION

### Packaging Container

A detergent pack comprises a packaging container containing 3 to 60 water-soluble unit-dose detergent products. The packaging container comprising a metallic layer at least partially encasing 3 to 60 water-soluble unit-dose detergent products. The packaging container can be a tub, tray, jar, bottle, bag, box, etc. Preferably the packaging container is recloseable. Preferably the packaging container is bag, preferably a flexible bag, more preferably a flexible reclosable bag, even more preferably a self-standing reclosable flexible bag. “Flexible” bag means a bag which can be easily deformed with a hand squeeze, preferably deformed by the mere act of holding the bag.

Preferably the metallic layer is a vacuum metalized layer of a vacuum metalized polymeric film. The metal is relatively thin at less than 5 microns thickness (but greater than 0 microns), preferably wherein the metal comprises aluminium. Such films are used in making of packaging containers, especially flexible packaging containers such as bags. Preferably the vacuum metalized polymeric film is: a vacuum metalized polyester film; preferably is a vacuum metalized polyethylene terephthalate film layer; more preferably is a vacuum aluminiumized polyethylene terephthalate film layer. Preferably the vacuum metalized polymeric film is one film layer of a multi-film layered film laminate (i.e., a laminate having 2, 3, 4 or more film layers). More preferably the vacuum metalized polymeric film is a middle film layer of a three-film layered laminate. For example, in the three-film layered laminate, the outermost film layer may be a reverse printed PET. The thickness of the outer most film layer may be from 6 microns to 25 microns, preferably from 8 microns to 16 microns, alternatively 8, 9, 10, 11, 12, 13, 14, or 15 microns in thickness. The innermost film layer, for example, may be polyester (PE), or preferably a linear low-density polyethylene (“LLDPE”) film layer. The thickness of the inner most film layer may be from 30 microns to 110 microns, preferably from 40 to 100 microns, more preferably from 50 to 80 microns; alternatively, from 60 microns to 80 microns, or 65 to 75 microns. The vacuum metalized middle polymer film layer may be a vacuum metalized polyester film, more preferably is a vacuum metalized polyethylene terephthalate (“PET”) film layer, more preferably is a vacuum aluminiumized PET film layer. The thickness of this middle film layer may be from 6 microns to 25 microns, preferably from 8 microns to 16 microns, alternatively 8, 9, 10, 11, 12, 13, 14, or 15 microns in thickness, wherein the provided thickness is inclusive of the metallic layer. The lamination technique can be solvent-based or solventless (preferably solventless) adhesive lamination. The thickness of the three-film layered laminate, especially if the packaging container is a bag, is from 70 microns to 130 microns, preferably from 80 microns to 120 microns, more preferably from 90 microns to 110 microns.

Preferably the metallic layer, of the packaging container, encases at least 25%, preferably at least 50%, more preferably at least 75%, yet more preferably at least 90%, of the inner surface of the container containing the unit-dose detergent products. The greater the percentage of encasement, the more of a moisture barrier is created to help mitigate against ammonia generation.

The packaging container contains from 3 to 60 water-soluble unit-dose detergent products, preferably from 10 to 40, more preferably from 15 to 35, of the products. Preferably the water-soluble unit-dose detergent products are water-soluble unit-dose automatic dishwashing detergent products. Yet more preferably the contained products are all essentially identical.

### Unit-Dose

Water-soluble unit-dose detergent products are described. “Unit-dose” means the detergent composition is provided in a form sufficient to provide enough detergent composition for one wash. Suitable unit dose products include sachets, capsules, pouches, moulds, etc. The detergent products weigh from 8 grams to 25 grams, preferably from 12 grams to 20 grams, more preferably 13 grams to 19 grams. This weight range fits within in an automatic dishwasher machine detergent composition dispenser.

An enveloping material envelopes the detergent composition. The enveloping material is any water-soluble material capable of enveloping the detergent composition. Preferably the enveloping material is made of polyvinyl alcohol. Preferably the enveloping material is a water-soluble polyvinyl alcohol film. Another example of enveloping material is a water-soluble injection-moulded mould. Both the detergent composition and the enveloping material are water-soluble. They readily dissolve when exposed to water, especially in an automatic dishwashing process, preferably during the main wash. The detergent products can have a single compartment or a plurality of compartments. The compartments can comprise a composition in liquid or solid form. Preferably the detergent composition or part thereof is in particulate form and enveloped by a water-soluble film, preferably having a thickness of less than 100 μm (but greater than 0 μm).

The enveloping material is water soluble. By “water-soluble” is herein meant that the material has a water-solubility of at least 50%, preferably at least 75% or even at least 95%, as measured by the method set out herein after using a glass-filter with a maximum pore size of 20 microns. 50 grams+−0.1 gram of enveloping material is added in a pre-weighed 400 ml beaker and 245ml+−1 ml of distilled water is added. This is stirred vigorously on a magnetic stirrer set at 600 rpm, for 30 minutes at 20° C. Then, the mixture is filtered through a folded qualitative sintered-glass filter with a pore size as defined above (max, 20 micron). The water is dried off from the collected filtrate by any conventional method, and the weight of the remaining material is determined (which is the dissolved or dispersed faction). Then, the % solubility can be calculated. The enveloping material is usually moisture permeable and ammonia permeable. Preferred substances for making the enveloping material include polymers, copolymers or derivatives thereof selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Especially preferred for use herein is polyvinyl alcohol and even more preferred polyvinyl alcohol films. Most preferred enveloping materials are PVA films known under the trade reference Monosol M8630, as sold by Kuraray, and PVA films of corresponding solubility and deformability characteristics.

Detergent composition

The detergent composition of the invention is presented in unit-dose form and it can be in any physical form including solid, liquid and gel form. The detergent composition comprises greater than 2.5 grams-active of malodour-generating aminocarboxylic complexing agent. Preferably the detergent composition comprises at least 2.7 grams-active, preferably at least 3 grams-active, more preferably at least 3.2 grams-active, yet more preferably at least 3.5 grams-active, yet still more preferably at least 3.7 grams-active; alternatively, from 2.7 to 9 grams-active, or from 3 to 7 grams-active. Preferably the aminocarboxylic complexing agent is selected from the group consisting of methyl glycine diacetic acid, its salts and derivatives thereof, glutamic-N,N-diacetic acid, its salts and derivatives thereof and mixtures thereof; preferably the aminocarboxylic acid is a salt of methyl glycine diacetic acid. Without wishing to be bound by theory, it is the higher amount of malodour-generating aminocarboxylic complexing agent that contributes to ammonia generation.

The aminocarboxylic complexing agent may be provided in particle form. The particle preferably comprises: (a) from 20 to 95%, more preferable from 40 to 60% by weight of the particle of aminocarboxylic acid, preferably a salt of methyl glycine diacetic acid, more preferably the tri-sodium salt; and (b) from 5 to 80% by weight of the particle of material selected from the group consisting of: i) polyalkylene glycol, preferably polyethylene glycol; ii) nonionic surfactant; iii) a polymer selected from the group consisting of polyvinyl alcohols, polyvinylpyrrolidones (PVP), and iii) a mixture thereof. Preferred polyethylene glycols in component (b) have an average molecular weight (weight-average molecular weight) of from 500 to 30,000 g/mol, more preferably of from 1000 to 5000 g/mol, most preferably from 1200 to 2000 g/mol. Nonionic surfactants in component (b) are preferably selected from the group consisting of alkoxylated primary alcohols, alkoxylated fatty alcohols, alkylglycosides, alkoxylated fatty acid alkyl esters, amine oxides and polyhydroxy fatty acid amides. Preferably the nonionic surfactant in component (b) has a melting point of above 20° C. The particle may be produced by dissolving components (a) and (b) in a solvent and spray-drying the resulting mixture, which may be followed by a granulation step. In this process, components (a) and (b) may be dissolved separately, in which case the solutions are subsequently mixed, or a powder mixture of the components may be dissolved in water. Useful solvents are all of those which can dissolve components (a) and (b); preference is given to using, for example, alcohols and/or water, particular preference to using water. Spray-drying is preferably followed by a granulation step. Preferably the particle has a weight geometric mean particle size of from 700 to 1000 μm with less than about 3% by weight above about 1180 μm and less than about 5% by weight below about 200 μm. Preferably the particle has a bulk density of at least 550 g/l, more preferably from 600 to 1,400 g/l, even more preferably from 700 g/1 to 1,200 g/l. This makes the particle suitable for use in detergent compositions, especially automatic dishwashing detergent compositions.

The detergent composition preferably further comprises a bleach. Without wishing to be bound by theory, the presence of bleach, although an effective cleaning agent, may exacerbate ammonia generation from the aminocarboxylic complexing agent (e.g., a salt of methyl glycine diacetic acid). The detergent composition preferably comprises from 1% to 20%, more preferably from 2 to 15%, even more preferably from 3 to 12% and especially from 4 to 10% by weight of the composition of a bleach. Inorganic and organic bleaches are suitable for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated. Suitable coatings include sodium sulphate, sodium carbonate, sodium silicate and mixtures thereof. Said coatings can be applied as a mixture applied to the surface or sequentially in layers.

Alkali metal percarbonates, particularly sodium percarbonate, is the preferred bleach for use herein. The percarbonate is most preferably incorporated into the products in a coated form which provides in-product stability. Preferably the detergent composition, of the water-soluble unit-dose detergent product, comprises a bleach, preferably wherein the bleach comprises percarbonate, more preferably the detergent composition further comprises from 1 gram-active to 5 grams-active, preferably from 1.5 to 4 grams-active, more preferably from 1.7 to 3 grams-active of sodium percarbonate.

The detergent composition may comprise a bleach activator. Bleach activators are typically organic peracid precursors that enhance the bleaching action in cleaning conditions at temperatures of 60° C. and below. Bleach activators suitable for use herein include compounds which, under perhydrolysis conditions, give aliphatic peroxoycarboxylic acids having preferably from 1 to 12 carbon atoms, and/or optionally substituted perbenzoic acid. If present, the detergent composition comprises from 0.01% to 1%, preferably from 0.2 to 0.5% by weight of the detergent composition of bleach activator, preferably TAED.

The detergent composition may comprise a bleach catalyst, preferably a metal containing bleach catalyst. More preferably the metal containing bleach catalyst is a transition metal containing bleach catalyst, especially a manganese or cobalt-containing bleach catalyst. Bleach catalysts preferred for use herein include manganese triazacyclononane and related complexes; Co, Cu, Mn and Fe bispyridylamine and related complexes; and pentamine acetate cobalt(III) and related complexes. Manganese bleach catalysts are preferred for use in the detergent compositions herein. Preferably the composition comprises from 0.001% to 0.5%, more preferably from 0.002 to 0.05% of bleach catalyst by weight of the composition. Preferably the bleach catalyst is a manganese bleach catalyst.

The detergent composition may comprise a dispersant polymer. The polymer, if present, is used in any suitable amount from 0.1% to 30%, preferably from 0.5% to about 20%, more preferably from 1% to 10% by weight of the composition. Preferably the dispersant polymer is a sulfonated polymer, more preferably a sulfonated polymer comprising 2-acrylamido-2-methylpropane sulfonic acid monomers and carboxyl monomers.

One example of a dispersant polymer is a polycarboxylate polymer. Suitable polycarboxylate-based polymers include polycarboxylate polymers that may have average molecular weights of from 500 Da to 500,000 Da, or from 1,000 Da to 100,000 Da, or even from 3,000 Da to 80,000 Da. Suitable polycarboxylates may be selected from the group comprising polymers comprising acrylic acid such as Sokalan PA30, PA20, PA15, PA10 and sokalan CP10 (BASF GmbH, Ludwigshafen, Germany), Acusol™ 45N, 480N, 460N and 820 (sold by Rohm and Haas, Philadelphia, Pa., USA) polyacrylic acids, such as Acusol™ 445 and Acusol™ 420 (sold by Rohm and Haas, Philadelphia, Pa., USA) acrylic/maleic co-polymers, such as Acusol™ 425N and acrylic/methacrylic copolymers. Alkoxylated polycarboxylates such as those prepared from polyacrylates are useful herein to and can provide additional grease suspension. Chemically, these materials comprise polyacrylates having one ethoxy side-chain per every 7-8 acrylate units. The side-chains are ester-linked to the polyacrylate “backbone” to provide a “comb” polymer type structure. The molecular weight can vary, but may be in the range of about 2000 to about 50,000. Unsaturated monomeric acids that can be polymerized to form suitable dispersing polymers include acrylic acid, maleic acid (or maleic anhydride), fumaric acid, itaconic acid, aconitic acid, mesaconic acid, citraconic acid and methylenemalonic acid. The presence of monomeric segments containing no carboxylate radicals such as methyl vinyl ether, styrene, ethylene, etc. is suitable provided that such segments do not constitute more than about 50% by weight of the dispersant polymer. Co-polymers of acrylamide and acrylate having a molecular weight of from about 3,000 to about 100,000, preferably from about 4,000 to about 20,000, and an acrylamide content of less than about 50%, preferably less than about 20%, by weight of the dispersant polymer can also be used. Most preferably, such dispersant polymer has a molecular weight of from about 4,000 to about 20,000 and an acrylamide content of from about 0% to about 15%, by weight of the polymer.

A preferred dispersant polymer is a sulfonated polymer. Suitable sulfonated polymers described herein may have a weight average molecular weight of less than or equal to about 100,000 Da, preferably less than or equal to about 75,000 Da, more preferably less than or equal to about 50,000 Da, more preferably from about 3,000 Da to about 50,000, and specially from about 5,000 Da to about 45,000 Da. The sulfonated polymers are preferably sulphonated polycarboxylate polymers comprising carboxylic acid monomers and sulfonated monomers. Preferred carboxylic acid monomers include one or more of the following: acrylic acid, maleic acid, itaconic acid, methacrylic acid, or ethoxylate esters of acrylic acids, acrylic and methacrylic acids being more preferred. Preferred sulfonated monomers include one or more of the following: sodium (meth) allyl sulfonate, vinyl sulfonate, sodium phenyl (meth) allyl ether sulfonate, or 2-acrylamido-methyl propane sulfonic acid. Preferred non-ionic monomers include one or more of the following: methyl (meth) acrylate, ethyl (meth) acrylate, t-butyl (meth) acrylate, methyl (meth) acrylamide, ethyl (meth) acrylamide, t-butyl (meth) acrylamide, styrene, or a-methyl styrene. Specially preferred sulfonated polymers for use herein are those comprising monomers of acrylic acid and monomers of 2-acrylamido-methyl propane sulfonic acid. In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions. Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Rohm & Haas; Goodrich K-798, K-775 and K-797 supplied by BF Goodrich; and ACP 1042 supplied by ISP technologies Inc. Particularly preferred polymers are Acusol 587G and Acusol 588G supplied by Dow, Versaflex Si™ (sold by Alco Chemical, Tennessee, USA). Preferably the detergent composition comprises a sulphonated polycarboxylate polymer, preferably from 0.1 grams-active to 1.1 grams-active, more preferably from 0.2 grams-active to 0.6 grams-active, of the sulphonated polycarboxylate polymer.

Suitable styrene co-polymers may be selected from the group comprising, styrene co-polymers with acrylic acid and optionally sulphonate groups, having average molecular weights in the range 1,000-50,000, or even 2,000-10,000 such as those supplied by Alco Chemical Tennessee, USA, under the tradenames Alcosperse® 729 and 747.

Other dispersant polymers useful herein include the cellulose sulfate esters such as cellulose acetate sulfate, cellulose sulfate, hydroxyethyl cellulose sulfate, methylcellulose sulfate, and hydroxypropylcellulose sulfate. Sodium cellulose sulfate is the most preferred polymer of this group. Yet other suitable dispersant polymers are the carboxylated polysaccharides, particularly starches, celluloses and alginates. Preferred cellulose-derived dispersant polymers are the carboxymethyl celluloses.

The detergent composition preferably comprises an inorganic builder. Suitable inorganic builders are selected from the group consisting of carbonate, silicate and mixtures thereof. Especially preferred for use herein is sodium carbonate. Preferably the composition of the invention comprises from 5% to 50%, more preferably from 10 to 40% and especially from 15 to 30% of sodium carbonate by weight of the composition.

The detergent composition preferably comprises a surfactant, preferably a non-ionic surfactant. Traditionally, non-ionic surfactants have been used in automatic dishwashing for surface modification purposes, especially for sheeting to avoid filming and spotting and to improve shine. It has been found that non-ionic surfactants can also contribute to prevent redeposition of soils. Preferably the composition of the invention comprises a non-ionic surfactant or a non-ionic surfactant system, more preferably the non-ionic surfactant or a non-ionic surfactant system has a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and better stability in product than single non-ionic surfactants. Suitable nonionic surfactants include: i) ethoxylated non-ionic surfactants prepared by the reaction of a monohydroxy alkanol or alkyphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii). Another suitable non-ionic surfactants are epoxy-capped poly(oxyalkylated) alcohols.

The detergent compositions may further comprise enzymes (e.g., proteases and/or amylases), crystal growth inhibitors, metal care agents, and/or glass care agents. In one example, the detergent composition comprises less than 0.4 grams-active, preferable less than 0.3 grams-active, more preferably less than 0.2 grams-active of citric acid; alternatively, the detergent composition is free of citric acid.

The detergent composition may be in the form of loose powder. “Loose-powder” means a powder comprising a plurality of independent particles, i.e., the particles are not bound to one another. When the loose powder is delivered into the dishwasher the particles in the wash liquor are found as individual entities rather than in the form of a single entity constituted by a plurality of particles. Pressed tablets are not considered a product comprising a particulate loose powder composition. Malodour generation in a loose powder can be faster. When the detergent composition is in particulate form, the enveloping material preferably has a pin hole to allow the escape of any gases that might form during the storage of the detergent product. This facilitates the escape of amine based malodours further contributing to the malodour of the detergent pack.

Preferably, the detergent composition is alkaline. “Alkaline” means that the pH of the composition is greater than 7, preferably greater than 9, more preferably from 9 to 12, yet more preferably from 9.5 to 11, yet still more preferably from 10 to 11 as measured in 1% weight/volume aqueous solution in distilled water at 20° C. Generally, high pH helps for cleaning performance; however, alkaline compositions can be more prone to chemical instability caused by moisture (thereby potentially exacerbating ammonia generation).

The detergent pack preferably has less than 100 parts per million, preferably less than 70 parts, more preferably less than 50 parts, yet more preferably less than 30 parts, yet still even more preferably less than 10 parts, of ammonia generated at 8 weeks while at 32° C. and 80% relative humidity.

### EXAMPLE

Comparative and inventive detergent packs are assessed for ammonia generation over 8 weeks. Water-soluble unit-dose detergent products notably each contains: 5.6 grams-active of tri-sodium salt of methyl glycine diacetic acid, sourced from BASF as Trilon U1G (“MGDA”) (another example is Trilon M SG); 0.4 grams-active of a sulphonated polycarboxylate polymer supplied by Dow under the tradename of ACUSOL 588™ (“Acusol 588”). These detergent products are the same between the comparative and inventive detergent packs. However, the packaging container in the form of a flexible reclose-able bag are different between these packs. Notable, the laminate of the bag of the inventive detergent pack comprises an additional middle film layer of vacuum metalized polyethylene terephthalate (PET). The metal is relatively thin at less than 5 microns thickness of aluminium (but greater than 0 microns). Both laminates have reverse printed PET as the outermost film layer (i.e., outer most facing layer). Printing is by way flexography. In the laminate of the comparative detergent pack, the reverse printed PET film layer is adhesive laminated to a linear low-density polyethylene (“LLDPE”) film layer. It is this LLDPE that forms in the innermost film layer (i.e., inner most facing layer). In the laminate of the inventive pack, the reverse printed PET film layer is adhesive laminated to the metalized PET layer and also adhesive laminated to a LLDPE film layer, thereby making a three-layer laminate (compared to the two-layer laminate of the comparative pack). The three-layer laminate has the metalized film layer through the entire laminate. The lamination technique is the same for either laminate as solventless adhesive lamination. The laminate of the comparative example is about 95 microns in total thickness, and inventive example is about 99 microns in total thickness.

Equal number (24 count) and equal kind of the unit dose detergent products are packaged in the respective bags and placed under controlled conditions at 32° C. and 80% relative humidity for the eight weeks, and then assessed for ammonia content at zero, four weeks, and eight weeks. At each of these time periods, the bags are pierced with an ammonia detector tube fitted to a Kitagawa (AP-20) gas aspirating pump to measure the concentration of airborne ammonia at parts per million (PPM) in the headspace of the bag. The results are provided in Table 1 below.

TABLE 1
Ammonia generation in comparative and inventive detergent packs over 8 weeks.

| | | Comparative: | Inventive: |
|---|---|---|---|
| Laminate | Outer Layer | 12 microns PET | 12 microns PET |
| components of | Middle Layer | — | 12 microns metalized |
| flexible reclose-able | | | PET |
| bag | Inner Layer | 80 microns LLDPE | 70 microns LLDPE |
| Unit Dose | Number in Bag | 24 count | 24 count |
| | Mass | 17.45 g (entire pouch) | 17.45 g (entire pouch) |
| Notable Ingredients | MGDA | 5.6 g-active | 5.6 g-active |
| in Unit Dose | Acusol 588 | 0.4 g-active | 0.4 g-active |
| (grams) | Citric Acid | 0 g | 0 g |
| Ammonia level at | 0 weeks | 0 ppm (at 37.5% eRH) | 0 ppm (at 37.5% eRH) |
| parts per million | 4 weeks | 0 ppm (at 43.5% eRH) | 0 ppm (at 42% eRH) |
| (wt % of free water | 8 weeks | 1000 ppm (at 46.8% eRH) | 0 ppm (at 41% eRH) |
| in the system (eRH)) | | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent pack comprising: a packaging container containing 3 to 60 water-soluble unit-dose detergent products;
wherein the packaging container comprising a metallic layer at least partially encasing the water-soluble unit dose detergent products;
wherein each of the water-soluble unit-dose detergent products comprises a detergent composition and an enveloping material enveloping the detergent composition; and
wherein the detergent composition comprises more than 2.5 grams-active of malodour-generating aminocarboxylic complexing agent.

2. The detergent pack of claim 1, wherein the metallic layer is a vacuum metalized layer of a vacuum metallized polymeric film.

3. The detergent pack of claim 2, wherein:
(a) the packaging container is a bag;
(b) the vacuum metalized polymer film is a film layer of a multi-film layered film having a thickness from 70 microns to 130 microns, and wherein the vacuum metalized layer encases at least 75% of the inner surface of the bag containing the unit-dose detergent products;
(c) mass of each water-soluble unit-dose detergent product is from 12 g to 20 g, and wherein the water-soluble unit-dose detergent products are water-soluble unit-dose automatic dishwashing detergent products;
(d) the detergent composition further comprises:
(i) a sulphonated polycaroxylate polymer;
(ii) a nonionic surfactant;
(iii) the aminocarboxylic complexing agent comprises at least 2.7 grams-active;
(iv) a pH at 1 weight percentage from 9 to 12; and
wherein the detergent pack as less than 70 parts per million of ammonia generated at 8 weeks at 32 degrees C. and 80% relative humidity.

4. The detergent pack of claim 2, where the packaging container is a recloseable flexible bag.

5. The detergent pack of claim 3, wherein the vacuum metalized polymeric film is a vacuum metalized polyester film.

6. The detergent pack of claim 5, wherein the vacuum metalized polyester film is a vacuum metalized polyethylene terephthalate film layer.

7. The detergent pack of claim 6, wherein the vacuum metalized polyethylene terephthalate film layer is a vacuum aluminumized polyethylene terephthalate film layer.

8. The detergent pack of claim 5, wherein the vacuum metalized polymeric film is a film layer of a three-film layered laminate.

9. The detergent pack of claim 8, wherein the vacuum metalized polymeric film is a is a vacuum aluminumized polyethylene terephthalate film layer; and the thickness of the three-film layered laminate is from 70 microns to 130 microns

10. The detergent pack of claim 9, wherein the metallic layer encases at least 25% of the inner surface of the container containing the unit-dose detergent products.

11. The detergent pack of claim 1, wherein the wherein the aminocarboxylic complexing agent is selected from the group consisting of methyl glycine diacetic acid, its salts and derivatives thereof, glutamic-N,N- diacetic acid, its salts and derivatives thereof and mixtures thereof; and wherein the aminocarboxylic complexing agent comprises at least 2.7 grams-active.

12. The detergent pack of claim 10, wherein the aminocarboxylic complexing agent is a salt of methyl glycine diacetic acid and comprises at least 3.2 grams-active.

13. The detergent pack claim 1, wherein the detergent composition further comprises from 0.1 grams-active to 1.1 grams-active of a sulphonated polycarboxylate polymer.

14. The detergent pack of claim 1, wherein the detergent composition comprises less than 0.4 grams-active of citric acid.

15. The detergent pack of claim 1, wherein the detergent composition further comprises from 1 gram-active to 5 grams-active of sodium percarbonate.

16. The detergent pack of claim 1, wherein the container contains from 10 to 40, of the water-soluble unit-dose detergent products, wherein the water-soluble unit-dose detergent products are water-soluble unit-dose automatic dishwashing detergent products.

17. The detergent pack of claim 1, wherein the enveloping material is a water-soluble film or a water-soluble injection-molded mold.

18. The detergent pack of claim 1, having less than 100 parts per million of ammonia generated at 8 weeks while at 32° C. and 80% relative humidity.

19. The detergent pack of claim 1, wherein the detergent composition further comprising from 0.5 grams-active to 3 grams-active of a nonionic surfactant.

20. The detergent pack of claim 1, wherein: mass of each water-soluble unit-dose detergent product is from 13 grams to 19 grams; and the detergent composition has a pH at 1 weight percentage is from 9.5 to 11.
